(19) United States
(12) Patent Application Publication
(10) Pub. No.: US 2019/0030543 A1
(43) Pub. Date: Jan. 31, 2019

(54) SLAG CRUSHER

(71) Applicant: MITSUBISHI HITACHI POWER SYSTEMS, LTD., Yokohama-shi, Kanagawa (JP)

(72) Inventors: Ryohei Ohashi, Tokyo (JP); Katsuhiko Yokohama, Tokyo (JP); Yoshinori Koyama, Tokyo (JP); Yasuyuki Miyata, Tokyo (JP); Yasunori Ishizu, Kanagawa (JP); Kengo Shibata, Kanagawa (JP); Masashi Kitada, Kanagawa (JP)

(73) Assignee: MITSUBISHI HITACHI POWER SYSTEMS, LTD., Yokohama-shi, Kanagawa (JP)

(21) Appl. No.: 16/081,226

(22) PCT Filed: Sep. 1, 2016
(86) PCT No.: PCT/JP2016/075674

§ 371 Date: Aug. 30, 2018

(30) Foreign Application Priority Data
Mar. 4, 2016 (JP) 2016-042387

(51) Int. Cl. B02C 1/00; B02C 23/16; C10J 3/52

(52) U.S. Cl. CPC B02C 1/005; B02C 23/02; C10J 3/52; B02C 23/16

(57) ABSTRACT

A slag crusher includes a screen provided so as to intersect a falling direction of a slag and having openings; at least two spreaders disposed opposite from one another on the screen; and a spreader moving unit configured to support the spreaders and move the spreaders in a direction vertical to the opposing faces of the spreaders. Each spreader includes projections and a lower projection so as to face the other spreader. In a state in which the lower projection is closest to the other spreader, the lower projection does not come into surface contact with the opposed lower projection, and a distance between the opposing lower projections is smaller than an opening dimension of the openings of the screen across a width direction of the spreaders.

### FIELD

The present invention relates to a slag crusher.

### BACKGROUND

A slag hopper in slag (molten slag) that has been produced in a combustor and has fallen therefrom is stored is included in the lower part of a gasifier that gasifies carbonaceous feedstock, such as coal (Patent Literature 1) .

The slag hopper is internally filled with cooling water, and includes in the lower part thereof a slag crusher having a screen and spreaders. The slag falling from the combustor is rapidly cooled by the cooling water and solidified, and fails onto the top surface of the screen of the slag crusher. The screen is provided in such a manner as to intersect the falling direction of the slag, and also includes a plurality of openings. This structure allows slag that is smaller than the opening dimension of the openings to pass through the screen and fall into the lower part of the slag hopper.

Meanwhile, slag that is larger than the opening dimension of the openings and a slag lump that is an accumulation of slag that is smaller than the opening dimension of the openings accumulate on the top surface of the screen. The slag lump accumulates on top of large slag covering the openings. The spreaders disposed opposite from one another on the top surface of the screen are then moved on the top surface of top screen by hydraulic cylinders, for example, and hold therebetween the slag that has accumulated on the top surface of the screen, and crush the slag by applying a force thereto, so as to allow the slag to pass through the screen.

### CITATION LIST

### Patent Literature

Patent Literature 1: Japanese Patent Application Laid-open No. 9-38510

### SUMMARY

### Technical Problem

Unfortunately, even if the spreaders are moved on the top surface of the screen to hold the slag therebetween, the slag may remain in gaps between the spreaders without being crushed, only gathering in the actuating direction of the spreaders, and fail to pass through the screen. More slag then accumulates on the top surface of the screen, and the slag is not discharged from the gasifier, filling the inside of the slag hopper. The area of the screen through which the slag passes is reduced, and the efficiency of discharging slag is decreased.

The present invention is made in view of the circumstances described above, and it is an object of the present invention to provide a slag crusher that enables slag that has accumulated on the top surface of a screen to efficiently pass through openings of the screen.

### Solution to Problem

To solve the problem described above, the present invention is a slag crusher that is provided in a gasifier for gasifying coal to crush slag that has been produced in the gasifier and has fallen from the gasifier. The slag crusher includes a screen provided so as to intersect a falling direction of the slag, the screen having a plurality of openings formed therein; at least two spreaders disposed on a top surface side of the screen, the spreaders being disposed opposite from one another; and a spreader moving unit configured to support the spreaders and cause the spreaders to move in a direction vertical to the opposing faces of the spreaders. The spreaders each include a plurality of projections and a lower projection, the projections being disposed on the opposing face to the other spreader that is disposed in an opposed position, the projections projecting toward the other spreader, the lower projection being disposed at a lower end of the opposing face, extending in a direction orthogonal to a moving direction of the spreaders, and projecting toward the other spreader. In a state in which the lower projection is located closest to the other spreader that is disposed opposite from the lower projection, the lower projection does not come into surface contact with the opposed lower projection, and a distance between the lower projection and the opposed lower projection is smaller than an opening dimension of the openings of the screen across a width direction of the spreaders.

It is preferable that the lower projection has a face opposing the screen, the face slanting in a direction moving away from the screen toward the opposed lower projection.

It is preferable that the lower projection has a concavo-convex shape in which, depending on a position in the direction orthogonal to the moving direction of the spreaders, an amount projecting toward the other spreader-varies, and the lower projection has an inverted shape of the concavo-convex shape of the opposed lower projection.

### Advantageous Effects Of Invention

According to the present invention, the slag that has accumulated on the top surface of a screen is allowed to efficiently pass through the openings of the screen.

### BRIEF DESCRIPTION OF DRAWINGS

FIG. 1 is a vertical sectional view of a gasifier according to a first embodiment of the present invention.

FIG. 2 is a plan view of a slag crusher according to the first embodiment of the present invention.

FIG. 3 is a front view of the slag crusher in a standby position according to the first embodiment of the present invention.

FIG. 4 is a front view of the slag crusher in a crushing position according to the first embodiment of the present invention.

FIG. 5 is a horizontal sectional view of spreaders and lower projections according to the first embodiment of the present invention.

FIG. 6 is a front view of a slag crusher in a standby position according to a second embodiment of the present invention.

FIG. 7 is a front view of the slag crusher in a crushing position according to the second embodiment of the present invention.

FIG. 8 is a horizontal sectional view of spreaders and lower projections according to the second embodiment of the present invention.

### DESCRIPTION OF EMBODIMENTS

The following describes in detail embodiments of the present invention with reference to the drawings. Note that the following description of the embodiments does not limit the present invention. Components in the embodiments described below include ones that a person skilled in the art can easily conceive of, ones that are substantially the same, or ones that fall within what is called a range of equivalency. Furthermore, various omissions, substitutions, combinations, and changes may be made as appropriate to configurations of the components disclosed in the embodiments described below without departing from the spirit of the present invention.

### First Embodiment

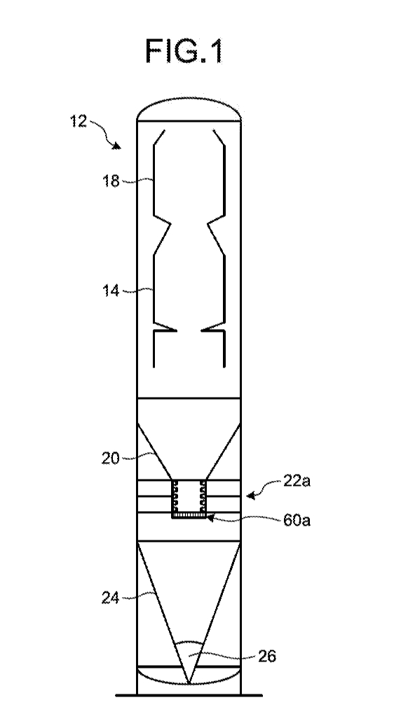

slag crasher 22a and a gasifier 12 according to a first embodiment are described with reference to the drawings. FIG. 1 is a vertical sectional view of a gasifier according to the first embodiment.

The gasifier 12 according to the first embodiment has a combustor 14, a reductor 18, a slag hopper 20, and a lower hopper 24.

The gasifier 12 produces combustible gas from carbonaceous feedstock. Examples of carbonaceous feedstock that is applied to the gasifier 12 include heavy fuels such as coal, petroleum coke, coal coke, asphalt, pitch, and oil shale, as well as wastes such as waste tires and plastics. A case in which the carbonaceous feedstock to be gasified is coal is described in the following embodiments.

In the gasifier 12, pulverised coal that is supplied from a coal feeding facility (not illustrated) and char that is supplied after being collected by a dedusting device (not illustrated) react with an oxygen containing gas in the combustor 14 in a high-temperature atmosphere of about 1,500 to 1,800° C that is equal to or higher than the ash melting point. In this way, the supplied pulverized coal and char are burned at a high temperature in the combustor 14, thus producing coal gas that is combustible gas, and also producing slag 16 containing melted ash content of the pulverized coal.

High-temperature coal gas resulting from high-temperature combustion of the combustor 14 flows into the reductor 18 provided above the combustor 14. Also in the reductor 18, pulverised coal is supplied, the supplied pulverized coal is further gasified, and combustible gas of coal gas is produced. Although the combustor 14 according to the first embodiment is of an entrained bed, the combustor 14 is not limited thereto and may be of a fluid bed or a fixed bed.

The slag hopper 20 is disposed under the combustor 14. The slag hopper 20 is internally filled with cooling water, and uses the cooling water to rapidly cool the slag 16 that has been produced in the combustor 14 and has fallen therefrom. The rapidly cooled slag 16 is solidified and gathered in the lower part of the slag hopper 20. In the lower part of the slag hopper 20, the slag crusher 22a is provided, which crushes the solidified slag 16 and discharges the crushed slag into the lower hopper 24.

Although the gasifier 12 according to the first embodiment adopts a gravity falling method in which the slag 16 is caused to fall into the lower hopper 24 and discharged out of the system, a used method is not limited thereto. For example, a horizontal suction method may be adopted in which the slag 16 is removed for reuse instead of falling into the lower hopper 24.

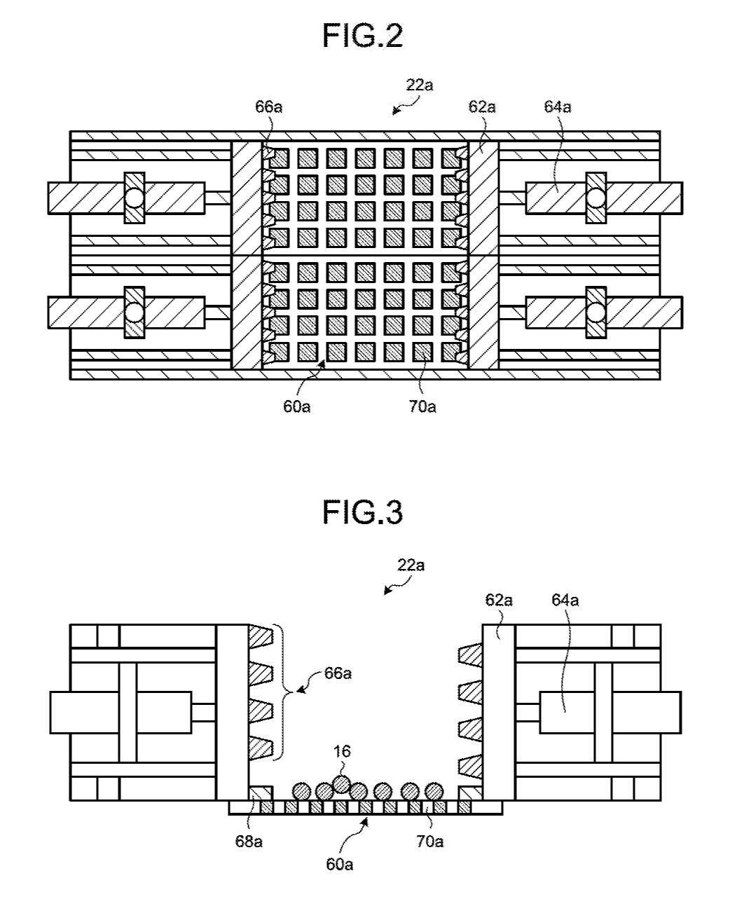

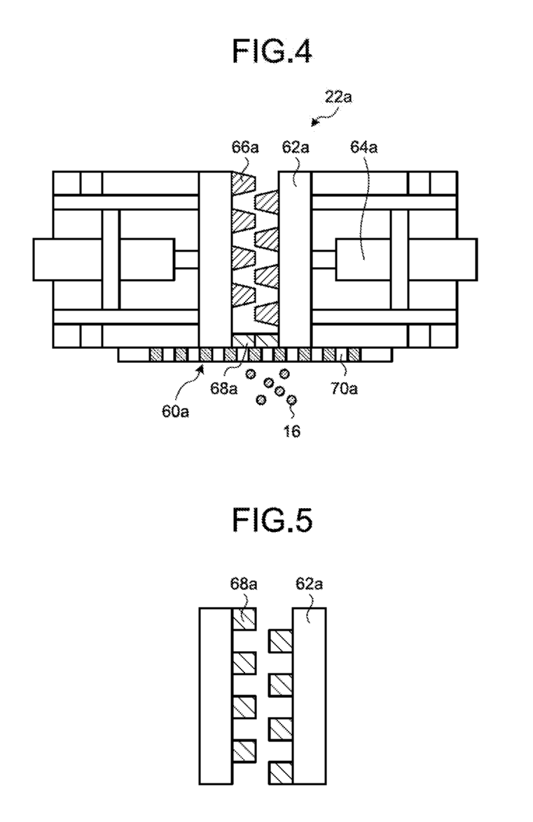

Next, the slag crusher 22a according to the first embodiment of the present invention is described with reference to FIGS. 2, 3, 4, and 5 in addition to FIG. 1. FIG. 2 is a plan view of the slag crusher 22a according to the first embodiment of the present invention. FIG. 3 is a front view of the slag crusher 22a in a standby position according to the first embodiment of the present invention. FIG. 4 is a front view of the slag crusher 22a in a crushing position according to the first embodiment of the present invention. FIG. 5 is a horizontal sectional view of spreaders 62a and lower projections 68a according to the first embodiment of the present invention.

The slag crusher 22a is disposed in the lower part of the slag hopper 20 that is filled with cooling water. The slag crusher 22a includes a screen 60a, the spreaders 62a, and hydraulic cylinders 64a.

The screen 66a has a plurality of rectangular openings 70a, and is a plate-like member through which the slag 16 that is smaller than the opening dimension of the openings 70a passes, as illustrated in FIG. 2. The screen 60a is provided in such a manner as to intersect the falling direction of the slag 16 that falls from the combustor 14. The slag 16 that falls from the combustor 14 falls into the cooling water with which the slag hopper 20 is filled, and is rapidly cooled and solidified. The solidified slag 16 falls onto the top surface of the screen 60a. The slag 16 that is larger than the opening dimension of the openings 70a accumulates on the top surface of the screen 60a. The shape of the openings 70a of the screen 60a is not limited to rectangular, and may be circular or polygonal, for example.

The spreaders 62a are two pairs of plate-like members, the members in each pair being disposed opposite from one another on the top surface of the screen 60a, as illustrated in FIGS. 2 and 3. The material of the spreaders 62a is stainless steel. The spreaders 62a are supported by the hydraulic cylinders 64a. The spreaders 62a are moved on the top surface of the screen 60a by the hydraulic cylinders 64a. The spreaders 62a are moved on the top surface of the screen 60a and sandwich the slag 16 that has accumulated on the top surface of the screen 60a. The position of the spreaders 62a illustrated in FIG. 3 represents a standby position of the spreaders 62a before the spreaders 62a are moved on the top surface of the screen 60a. The position of the spreaders 62a illustrated in FIG. 4 represents a position (hereinafter, a crushing position) of the spreaders 62a after the spreaders 62a have been moved on the top surface of the screen 60a and are closest to the opposed spreaders 62a. Although spreaders 62a, 62b are two pairs of plate-like members, the members in each pair being disposed opposite from one another, the number of pairs of spreaders is not particularly limited.

Each spreader 62a has projections 66a and the lower projection 68a provided on the opposing face thereof. The projections 66a are provided on the upper part of the opposing face of the spreader 62a. The projections 66a are conical in shape, and project from the opposing face of the spreader 62a toward the opposed spreader 62a. The projections 66a are disposed in plural on the surface of the spreader 62a with a space left between one another. The projections 66a are fixed to the opposing faces of the spreaders 62a by welding. The material of the projections 66a is stainless steel, for example. Although the projections 66a illustrated in FIG. 2 each have a truncated quadrangular pyramid shape as an example, they may have a circular cone, circular truncated cone, polygonal pyramid, or truncated polygonal pyramid shape, for example.

The lower projection 68a is provided on the lower part of the opposing face of each spreader 62a, that is to say, closer to the lower side in the vertical direction than the projections 66a are. The lower projection 68a has a face on the lower side in the vertical direction facing the screen 60a. The lower projections 68a extend in the horizontal direction. The lower projections 68a are fixed to the opposing faces of the spreaders 62a by welding. The material of the lower projections 68a is stainless steel, for example. Each lower projection 68a is disposed opposite from the opposed lower projection 68a across the width direction of the spreaders 62a so as to alternately engage with one another, as illustrated in FIG. 5. In other words, the lower projection 68a has a concavo-convex shapes in which, depending on the position in a direction orthogonal to the moving direction of the spreaders, the amount projecting toward the other spreader varies. In addition, the lower projection 68a has as inverted shape of the concavo-convex shape of the opposed lower projection 68a. This structure enables concave portions of the lower projection 68a and convex portions of the opposed lower projection 68a to be located in the same position in the horizontal direction and convex portions of the lower projection 68a and concave portions of the opposed lower projection 68a to be located in the same position in the horizontal direction, which makes concave and convex portions engage with one another when the lower projections 68a and the opposed lower projection 68a are brought close to one another.

Although the projections 66a and the lower projections 68a are fixed to the opposing faces of the spreaders 62a by welding, the way of fixation is not particularly limited. They may have an integral structure by casting.

In a state in which the spreaders 62a have been moved to the crushing position by the hydraulic cylinders 64a, the lower projections 68a are provided on the spreaders 62a in a length in which the distance from the opposed lower projections 68a is smaller than the opening dimension of the openings 70a of the screen 60a across the width direction of the spreaders 62a. In a state in which the spreaders 62a have been moved to the crushing position by the hydraulic cylinders 64a, the lower projections 68a are provided on the spreaders 62a in a length in which the lower projections 68a do not come into surface contact with the opposed lower projections 68a across the width direction. The distance between the lower projections 68a and the lower projections 68a that are in an opposed position is smaller than the distance between the projections 66a and the projections 66a that are in an opposed position (the opposing faces of the spreaders 62a when there are no projections 66a in the opposed position). Specifically, each lower projection 68a projects in the moving direction (the moving direction of the spreaders 62b) more than the projections 66a disposed on the opposing face of the same spreader 62a do, when the slag crusher 22a is viewed from the width direction of the spreaders 62a.

The slag crusher 22a according to the first embodiment has the structure as described above. The slag 16 produced in the combustor 14 falls into the cooling water with which the slag hopper 20 is filled, and is rapidly cooled and solidified. At this time, by being rapidly cooled, most of the slag 16 is broken into pieces of slag having a particle size of a few millimeters to several tens of millimeters, while some pieces of the slag 16 having a particle size larger than the foregoing are mixed. The solidified slag 16 falls onto the screen 60a. Of the slag 16 that has fallen onto the top surface of the screen 60a, the slag 16 that is smaller than the opening dimension of the openings 70a of the screen 60a passes through the openings 70a and falls into the lower hopper 24. Meanwhile, the slag 16 that is larger than the opening dimension of the openings 70a fails to pass through the openings 70a and accumulates on the top surface of the screen 60a. The spreaders 62a are then moved from the standby position to the crushing position on the top surface of the screen 60a at a predetermined time interval. The spreaders 62a gather the slag 16 that has accumulated on the top surface of the screen 60a when being moved to the crushing position. The spreaders 62a that have been moved to the crushing position sandwich the stag 16 between the projections 66a disposed on the opposing faces and the projections 66a disposed on the opposing faces of the spreaders 62a that are in the opposed position, thereby crushing the slag 16 that has accumulated, so as to allow the slag 16 to easily pass through the openings 70a.

Of the slag 16, the slag 16 having a particle size that is smaller than the distance between the projections 66a facing one another in the crushing position and that is larger than the openings 70a is not crushed by being sandwiched between the projections 66a facing one another, fails to pass through the openings 70a, and accumulates on the top surface of the screen 60a. The lower projections 68a provided on the lower part of the opposing faces of the spreaders 62a sandwich the slag 16 that has accumulated on the top surface of the screen 60a, leaving therebetween such a distance that is smaller than the opening dimension of the openings 70a and that the lower projections 68a do not come into surface contact with one another. In this way, the slag is broken into pieces and passes through the screen 60a.

In the slag crusher 22a according to the first embodiment, the distance between the lower projections 68a facing one another that are disposed on the lower part of the spreaders 62a in the crushing position is smaller than the opening dimension of the screen 60a, and, with such distance, the lower projections 68a do not come into surface contact with one another, across the width direction of the spreaders 62a. This structure enables the lower projections 68a to crush the slag 16 that has accumulated on the top surface of the screen 60a into pieces of slag each having a particle size that is smaller than the opening dimension of the screen 60a, which facilitates discharge of the slag 16 through the screen 60a. This structure also enables the lower projections 68a facing one another to be prevented from coming into contact with one another, which can prevent mechanical damage to the lower projections 68a and damage to a hydraulic system from excessive pressure being applied to the hydraulic cylinders 64a.

In the slag crusher 22a according to the first embodiment, each lower projection 68a is disposed opposite from the opposed lower projection 68a so as to alternately engage with one another. With this structure, the slag 16 can be crushed while the slag's escape route is blocked by the convex portions of the lower projections 68a located on each side of the spreaders 62a in the width direction. In this way, the slag can be prevented from being spread to and accumulating at outer ends of the spreaders 62a in the width direction. The area of the lower projections 68a that contributes to crushing can also be increased, which enables the slag 16 to be crushed more efficiently.

In the slag crusher 22a according to the first embodiment, the projections 66a and the lower projections 68a are fixed by welding. Thus, when the projections 66a and the lower projections 68a are worn or mechanically damaged, they can be replaced with new members, and maintenance can be easily done.

The slag crusher 22a according to the first embodiment, therefore, allows the slag 16 that has accumulated on the top surface of the screen 60a to easily pass through the openings 70a of the screen 60a. With this structure, even if the slag 16 accumulates on the top surface of the screen 60a, the slag crusher 22a enables the slag 16 to be discharged in a more reliable manner. As a result, the gasifier 12 can be prevented from being shut down because of accumulation of the slag 16, and the gasifier 12 can be operated continuously.

The distance between the lower projections 68a and the screen 60a is preferably equal to or less than two-and-a-half times the opening dimension or the screen. With such distance, the slag 16 can be prevented from remaining in gaps between the lower projections 68a and the screen 60a, and the lower projections 68a can sandwich and crush the slag 16 in a more reliable manner.

Although the spreaders 62a are disposed opposite from one another on the top surface of the screen 60a, each spreader 62a may be disposed opposite from a receiving wall that is disposed on the screen 60a, and the spreader 62a may be moved toward a receiving plate. With this structure, the number of pieces of drive equipment such as the hydraulic cylinders 64a, 64b can be decreased, and the manufacturing cost for the slag crusher 22a can be reduced.

### Second Embodiment

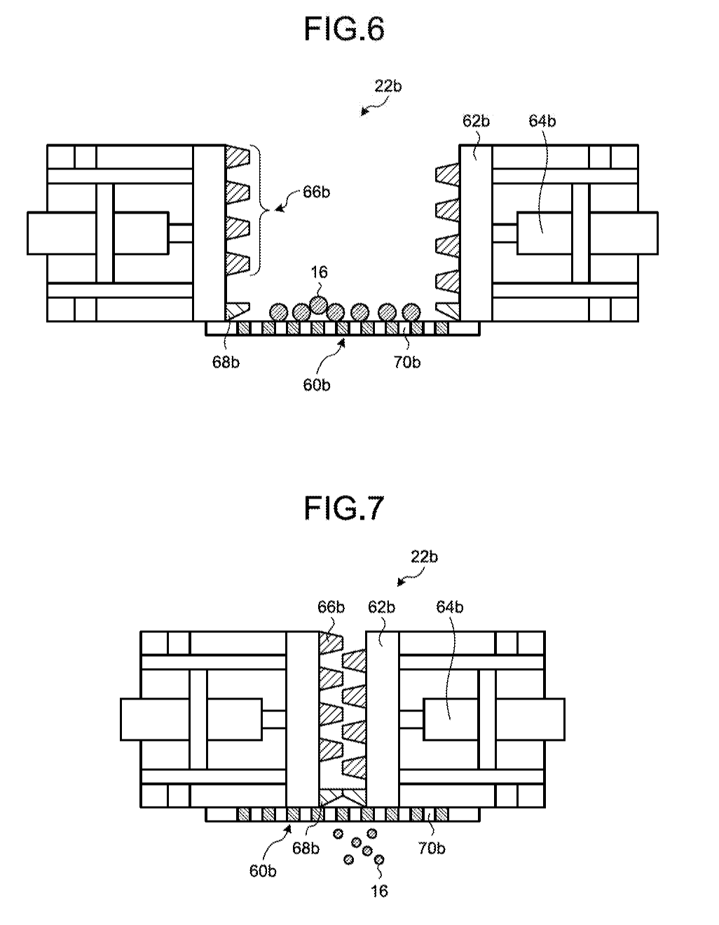

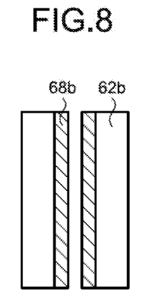

Next, a slag crusher 22b according to a second embodiment is described with reference to FIGS. 6, 7, and 8. FIG. 6 is a front view of the slag crusher 22b in a standby position according to the second embodiment of the present invention. FIG. 7 is a front view of the slag crusher 22b in a crushing position according to the second embodiment of the present invention. FIG. 8 is a horizontal sectional view of the spreaders 62b and lower projections 68b according to the second embodiment of the present invention. The slag crusher 22b of the second embodiment can be applied to the gasifier 12 in place of the slag crusher 22a of the first embodiment described above. In other words, the gasifier of the second embodiment has the same structure as the gasifier 12 except the slag crusher 22b.

The slag crusher 22b illustrated in FIGS. 6 and 7 includes a screen 60b, the spreaders 62b, hydraulic cylinders 64b, projections 66b, and the lower projections 68b. The slag crusher 22b has the same structure as the slag crusher 22a except the shape of the lower projections 68b.

The lower projections 68b are provided on the lower part of the opposing faces of the spreaders 62b. The lower projections 68b each have a face on the lower side in the vertical direction, that is to say, a face opposing the screen 60b, slanting upward in the direction from the opposing faces to the opposed spreaders 62b, as illustrated in FIGS. 6 and 7. The faces facing one another of the lower projection 68b and the lower projection 68b that is disposed in the opposed position are flat and parallel to one another across the width direction of the spreaders 62b, as illustrated in FIG. 8. In a state in which the spreaders 62b have been moved to the crushing position by the hydraulic cylinders 64b, the lower projections 68b have a thickness in which the distance from the opposed lower projection 68b is smaller than the opening dimension of openings 70b of the screen 60b across the width direction of the spreaders 62b. In a state in which the spreaders 62b have been moved to the crushing position by the hydraulic cylinders 64b, the lower projections 68b do not come into surface contact with the opposed lower-projections 68b across the width direction. The distance between the lower projections 68b and the lower projections 68b that are in the opposed position is smaller than the distance between the projections 66b and the projections 66b that are in the opposed position. Specifically, each lower projection 68b projects in the moving direction (the moving direction of the spreaders 62b) more than the projections 66b disposed on the opposing face of the same spreader 62b when the slag crusher 22b is viewed from the width direction of the spreaders 62b.

The slag crusher 22b according to the second embodiment has the structure as described above. When the spreaders 62b are moved to the crushing position, the lower projections 68b are moved to the crushing position while gathering the slag 16 that has accumulated on the top surface of the screen 60b in spaces between the slanting faces of the lower projections 68b and the screen 60b. At this time, the slanting faces of the lower projections 68b apply downforce to the slag 16 and crush the slag 16. Friction force generated between the slag 16 and the screen 60b is increased with the downforce applied to the slag 16. The slag 16 is crushed by the friction force generated with the screen 60b. In addition, part of the slag 16 is fitted into the openings 70b of the screen 60b by the downforce applied from the lower projections 68b. In such a state, the lower projections 68b are moved in the moving direction (the moving direction of the spreaders 62b), and apply horizontal force to the slag 16 fitted into the openings 70b so as to crush the slag 16 in a clipping manner.

The lower projections 68b according to the second embodiment each have a face slanting upward in the direction in which the spreaders 62b are moved to the crushing position. With this structure, when the lower-projections 68b are moved in the moving direction (the moving direction of the spreaders 62b), the slag 16 can be crushed by downforce applied thereto, which facilitates discharge of the slag 16 through the openings 70b of the screen 60b.

The present invention has been described with reference to the above embodiments. However, the technical scope of the present invention is not limited to the scope described in the above embodiments. Various changes or improvements may be made to the above embodiments without departing from the spirit of the invention. Any embodiment to which the changes or improvements are made are also included in the technical scope of the present invention. The above embodiments may also be combined.

For example, the shape of the lower projections 68b in the slag crusher 22b may be changed from being flat and parallel to the shape of the lower projections 68a alternately engaging with one another.

### REFERENCE SIGNS LIST

12 Gasifier

14 Combustor

16 Slag

18 Redactor

20 Slag hopper

22a, 22b Slag crushers

24 Lower hopper

26 Passing slag

60a, 60b Screens

62a, 62b Spreaders

64a, 64b Hydraulic cylinders

66a, 66b Projections

68a, 68b Lower projections

70a, 70b Openings

1. A slag crusher that is provided in a gasifier for gasifying coal to crash slag that has been produced in the gasifier and has talks from the gasifier, the slag crasher comprising:
a screen provided so as to intersect a falling direction of the slag, the screen having a plurality of openings formed therein;
at least two spreaders disposed on a top surface side of the screen, the spreaders being disposed opposite from one another; and
a spreader moving unit configured to support the spreaders and cause the spreaders to move in a direction vertical to the opposing faces of the spreaders, wherein
the spreaders each include a plurality of projections and a plurality of lower projections, the projections being disposed on the opposing face to the other spreader that is disposed in an opposed position, the projections projecting toward the other spreader, the lower projections being disposed at a lower end of the opposing face, extending in a direction orthogonal to a moving direction of the spreaders, and projecting toward the other spreader, and
in a state in which the lower projections are located closest to the other spreader that is disposed opposite from the lower projections, the lower projections do not come into surface contact with the opposed lower projection projections, and a distance between the lower projections and the opposed lower projections is smaller than an opening dimension of the openings of the screen across a width direction of the spreaders, wherein the lower projections have a concavo-convex shape in which, depending on a position in the direction orthogonal to the moving direction of the spreaders, an amount projecting toward the other spreader varies, and the lower projections have an inverted shape of the concavo-convex shape of the opposed lower projections such that each lower projection and each opposed lower projection are alternately engaged with one another.

2. The slag crasher according to claim 1, wherein, the lower projection has a face opposing the screen, the face slanting in a direction moving away from the screen toward the opposed lower projection.

3. (canceled)
